(19) United States
(12) Patent Application Publication
(10) Pub. No.: US 2003/0137903 A1
(43) Pub. Date: Jul. 24, 2003

(54) Portable timepiece

(76) Inventors: Haruki Hiranuma, Chiba-shi (JP); Hisamitsu Yoshikawa, Chiba-shi (JP)

Correspondence Address: ADAMS & WILKS, 31st Floor, 50 Broadway, New York, NY, 10004, US

(21) Appl. No.: 10/345,752

(22) Filed: Jan. 16, 2003

(30) Foreign Application Priority Data
Jan. 24, 2002 (JP) 2002-015934

(51) Int. Cl. G04B 37/00

(52) U.S. Cl. 368/282

(57) ABSTRACT

To form a timepiece body and a strap so that the timepiece body and strap can be connected to and disconnected from each other easily. A strap is connected to a case by moving a stepped pin, which is formed on a bow so as to be integral therewith, via a joint hole portion, and engaging the stepped pin with a smaller-diameter hole portion in a strap-connecting intermediate fastening plate formed on an clasp so as to be integral therewith. When a smaller-diameter portion passes through the joint hole portion, springs are bent, and the joint hole portion is expanded. This structure is formed so that, in the condition in which the connecting of the strap to the case is completed, a distance L1 between a larger-diameter hole portion and the nearest end portion of the clasp and that L2 between the smaller-diameter hole portion and the nearest end portion of the clasp are shorter than a distance L3 between the smaller-diameter hole portion and the nearest end portion of the case; and a distance L between the smaller-diameter hole portion and the end portion of the clasp which is the closest to the case is shorter than the distance L3. Therefore, the strap does not fall inadvertently.

### BACKGROUND OF THE INVENTION

The present invention relates to a strap connecting and disconnecting structure for portable timepieces, including a wristwatch.

The connecting of a strap to a case for a timepiece body of a portable timepiece including a wristwatch, etc. by using a related art strap connecting structure is done via a spring rod and the like. The fastening of a portable timepiece around the arm and removing of the same therefrom are done by using a special clasp and a buckle fixed to the strap.

This enables a portable timepiece to be fastened around the arm.

However, in order to replace a strap, it is difficult that the strap is removed from and connected to the case by one momentary action, and using a special jig becomes necessary.

In the case of a structure using an clasp and a buckle, a strap is fixed at the same portion thereof to a timepiece body at all times. Therefore, when the strap is a leather strap, it is worn out early.

Moreover, such a structure scarcely gives an impression that a combination of the case for the timepiece body and strap has a unitary appearance.

The present invention has a problem of enabling a timepiece body and a strap to be connected to and disconnected from each other easily.

The invention further has a problem of enabling damage to a strap to be lessened.

The invention further has a problem of enabling a strap to be formed so as to give an impression that a combination of the strap and a case for a timepiece body has a unified appearance.

### SUMMARY OF THE INVENTION

According to the present invention, a strap connecting and disconnecting structure for portable timepieces each of which has a timepiece body in which a movement is held in a case, a bow provided on the case so as to be integral therewith, and a strip, which is fastened to the bow, is provided, the structure including a fixing unit fastened to the strap, a locking pin provided on either the fixing unit or the bow, and a locking hole engaged with the locking pin and provided in the other thereof, the locking pin having a larger-diameter portion and a smaller-diameter portion, the locking hole having a larger-diameter hole portion larger than the larger-diameter portion, a smaller-diameter hole portion smaller than the larger-diameter portion and larger than the smaller-diameter potion, and a joint hole portion having a width smaller than that of the smaller-diameter portion, and adapted to be expanded when the smaller-diameter portion passes therethrough, and connect the larger-diameter hole portion and smaller-diameter hole portion together. The joint hole portion provided in the fixing unit or bow is expanded when the smaller-diameter portion provided on the bow or fastening member passes therethrough, and the smaller-diameter portion engages the smaller-diameter hole.

This structure may be formed so that, in the condition in which the fastening of the fixing unit to the bow by engaging the locking pin and the smaller-diameter hole portion with each other is completed, a distance between the center of the larger-diameter hole portion and the nearest end portion of the fixing unit and that between the center of the smaller-diameter hole portion and the nearest end portion of the fixing unit are shorter than a distance between the center of the smaller-diameter hole portion and the end portion of the fixing unit which is the closest to the case.

The structure may also be formed so that spring-forming holes are provided in the vicinity of the joint hole portion, springs being thereby formed between the joint hole portion and spring-forming holes, the springs being expanded by the locking pin when the locking pin passes through the joint hole portion, to cause the joint hole portion to be expanded.

According to the invention, a strap connecting and disconnecting structure for portable timepieces each of which has a timepiece body in which a movement is held in a case, a bow provided on the case so as to be integral therewith, and a strap, which is fastened to the bow, is provided, the structure including first and second bows provided on both of opposite sides of the case, and first and second fixing units provided on both end portions of the strap, a first locking pin being provided on either the first fixing unit or the first bow, a first locking hole engaged with the first locking pin being provided in the other thereof, a second locking pin being provided on either thereof, a second locking pin being provided on either the second fixing unit or the second bow, a second locking hole engaged with the second locking pin being provided in the other thereof, the first and second locking pins having first and second larger-diameter portions and first and second smaller-diameter portions, the first and second locking holes having first and second larger-diameter hole portions larger than the first and second larger-diameter portions, first and second smaller-diameter hole portions smaller than the first and second larger-diameter portions and larger than the first and second smaller-diameter portions, and first and second joint hole portions having widths smaller than those of the first and second smaller diameter portions, and adapted to be expanded when the first and second smaller-diameter portions pass therethrough and connect the first and second larger-diameter hole portions and first and second smaller-diameter hole portions together. The joint hole portions provided in the first and second fixing units or first and second bows are expanded when the smaller-diameter portions provided on the first and second bows or first and second fixing units pass therethrough, and the smaller-diameter portions engage the smaller-diameter hole portions.

This structure may also be formed so that, in the condition in which the fastening of the fixing units to the bows by engaging the first and second locking pins and the first and second smaller-diameter hole portions with each other is completed, each of distances between the centers of the first and second larger-diameter hole portions and the nearest end portions of the first and second fixing units and each of those between the centers of the first and second smaller-diameter hole portions and the nearest end portions of the first and second fixing units are shorter than each of distances between the centers of the first and second smaller-diameter hole portions and the end portions of the fixing units which are closest to the case.

The structure may also be formed by providing first and second spring-forming holes in the vicinity of the first and second joint hole portions, and thereby forming first and second springs between the first and second joint hole portions and first and second spring-forming holes so that the first and second springs are expanded by the first and second locking pins when the first and second locking pins pass through the first and second joint hole portions, to cause the first and second joint hole portions to be expanded.

### BRIEF DESCRIPTION OF THE DRAWINGS

FIG. 1 is a plan view showing the strap connecting and disconnecting structure for portable timepieces according to the first mode of embodiment of the present invention;

FIG. 2 is a sectional view taken along the line X-X in FIG. 1;

FIGS. 3 are explanatory drawings showing a process for fixing the strap connecting and disconnecting structure for portable timepieces according to the first mode of embodiment of the present invention; and

FIG. 4 is a plan view showing the strap connecting and disconnecting structure for portable timepieces according to the second mode of embodiment of the present invention.

### DETAILED DESCRIPTION OF THE PREFERRED EMBODIMENTS

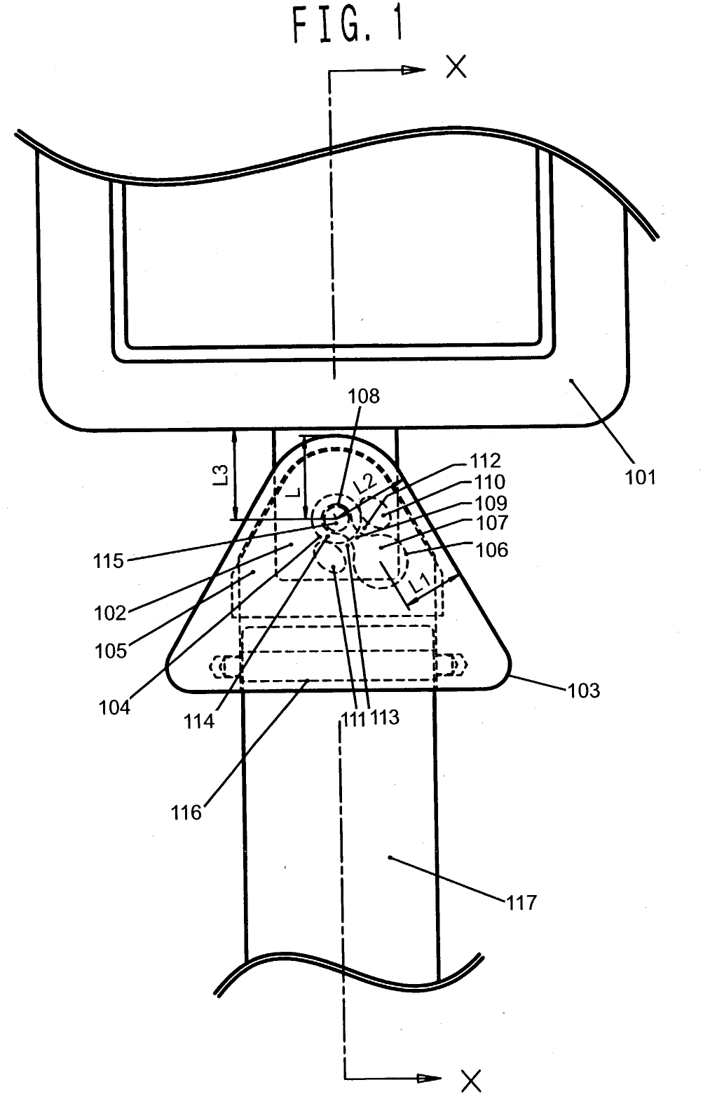

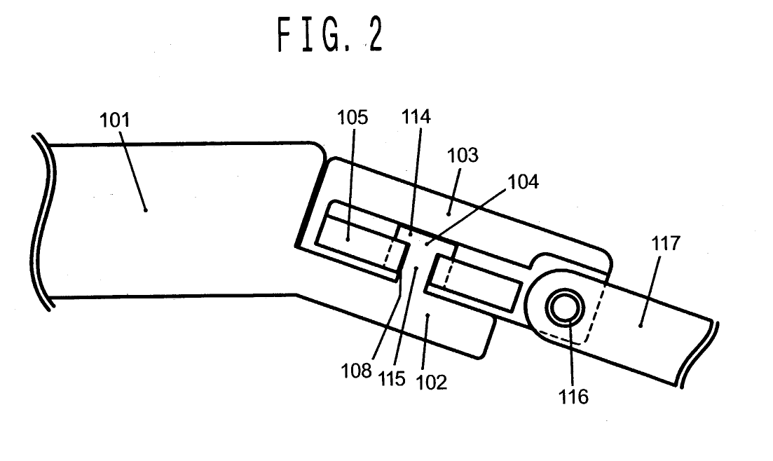

FIG. 1 is a plan view showing a first mode of embodiment of the strap connecting and disconnecting structure for portable timepieces according to the present invention, the drawing showing a case of a wristwatch as an example. FIG. 2 is a sectional view taken along the arrow-carrying line X-X in FIG. 1. The parts identical with those shown in FIG. 1 are designated by the same reference numerals.

Referring to FIG. 1 and FIG. 2, a reference numeral 101 denotes a case 101 for a timepiece body, adapted to hold a movement, such as a movement therein, 102 a bow provided on the case 101 so as to be integral therewith, 103 an clasp, and 117 a strap for fastening the timepiece body around the arm, etc. The strap 117 is fixed to a spring rod 116 secured to the clasp 103.

A stepped pin 104 having a larger-diameter portion 114 made of a circular plate type member of a predetermined diameter, and a smaller-diameter portion 115 made of a columnar member of a predetermined diameter smaller than that of the larger-diameter portion 114 is formed on the portion of the bow 102 which is on the side of the clasp 103 so that the stepped pin is integral with the bow. The stepped pin 104 forms a locking pin.

The clasp 103 holds therein a flat strap-connecting intermediate fastening plate 105 so that the plate 105 is integral with the clasp. The clasp 103 and the strap-connecting intermediate fastening plate 105 form a fixing unit.

The strap-connecting intermediate fastening plate 105 has a locking hole 106. The locking hole 106 has a larger-diameter hole portion 107 larger than the larger-diameter portion 114, a smaller-diameter hole portion 108 smaller than the larger-diameter portion 114 and larger than the smaller-diameter portion 115, and a joint hole portion 109 having a width smaller than the diameter of the smaller-diameter portion 115 and connecting the larger-diameter hole portion 107 and smaller-diameter hole portion 108 together. The joint hole portion 109 is expanded when the smaller-diameter portion 115 passes therethrough with an operating force of not lower than a predetermined level exerted thereon, to allow the passage of the smaller-diameter portion 115 therethrough.

The strap-connecting intermediate fastening plate 105 has a plurality of spring-forming holes 110, 111 in the vicinity of the joint hole portion 109, and, owing to this arrangement, a plurality of springs 112, 113 having a resiliency are formed between the joint hole portion 109 and spring-forming holes 110, 111. The springs 112, 113 work so as to be expanded by the pin 104 when the pin 104 passes through the joint hole portion 109 with an operating force of not lower than a predetermined level, to cause the joint hole portion 109 to be expanded; and work so as to restore its original condition after the pin 104 passes through the joint hole portion 109, and return the expanded joint hole portion 109 to its original smaller-width-carrying condition.

Although this mode of embodiment is formed so that a plurality of spring-forming holes 110, 111 are provided, it is not always strictly necessary that the spring-forming holes 110, 111 be provided plural. Even one spring-forming hole may be provided as long as the connecting and disconnecting of the strap 117 by a suitable operating force can be done. When the strap-connecting intermediate fastening plate 105 has an elasticity, the intermediate fastening plate 105 itself fulfils the function of the springs 112, 113, so that the spring-forming holes 110, 111 can be omitted.

When the strap 117 is fixed to the case 101, the smaller-diameter portion 115 of the pin 104 is in engagement with the smaller-diameter hole portion 108.

The structure is formed so that, when the fixing of the strap 117 to the case 101 is completed (when the fastening of the timepiece around the arm, etc. is completed (properly fastened condition) by the strap 117), i.e., when the fixing of the strap 117 is completed by engaging the pin 104 and smaller-diameter hole portion 108 with each other, a distance L1 between the center of the larger-diameter hole portion 107 and the nearest end portion of the fixing unit (especially, the clasp 103) and that L2 between the center of the smaller-diameter hole portion 108 and the nearest end portion of the fixing unit (especially, the clasp 103) become shorter respectively than a distance L between the center of the smaller-diameter hole portion 108 and the end portion of the fixing unit (especially, the clasp 103) which is the closest to the case 101.

In other words, the structure is formed so that the distance L1 between the center of the larger-diameter portion 114 and the nearest end portion of the clasp 103, and that L2 between the center of the smaller-diameter portion 115 and the nearest end portion of the clasp 103 become respectively shorter than the distance L between the center of the smaller-diameter portion 115 and the end portion of the clasp 103 which is the closest to the case 101.

The structure is formed so that, in the properly fixed condition thereof, the distance L between the center of the smaller-diameter hole portion 108 and the end portion of the clasp 103 which is the closest to the case 101 becomes shorter than a distance L3 between the center of the smaller-diameter hole 108 and the nearest end portion of the case 101.

Accordingly, the structure is formed so that the distance L1 between the center of the larger-diameter hole portion 107 and the nearest end portion of the clasp 103, and the distance L2 between the center of the smaller-diameter hole portion 108 and the nearest end portion of the clasp 103 become respectively shorter than the distance L3 between the center of the smaller-diameter hole portion 108 and the nearest end portion of the case 101.

FIG. 1 and FIG. 2 show only one each of the constituent elements including the bow 102, clasp 103, pin 104, etc. However, the case 101 is provided with one each constituent element including the bow 102, pin 104, etc. at both of the opposite sides thereof. The strap 117 is provided with one each constituent element including the fixing unit, etc. on both end portions thereof. In this structure, an operation for connecting the strap to the case is carried out by securing each of the fixing units to the corresponding bow.

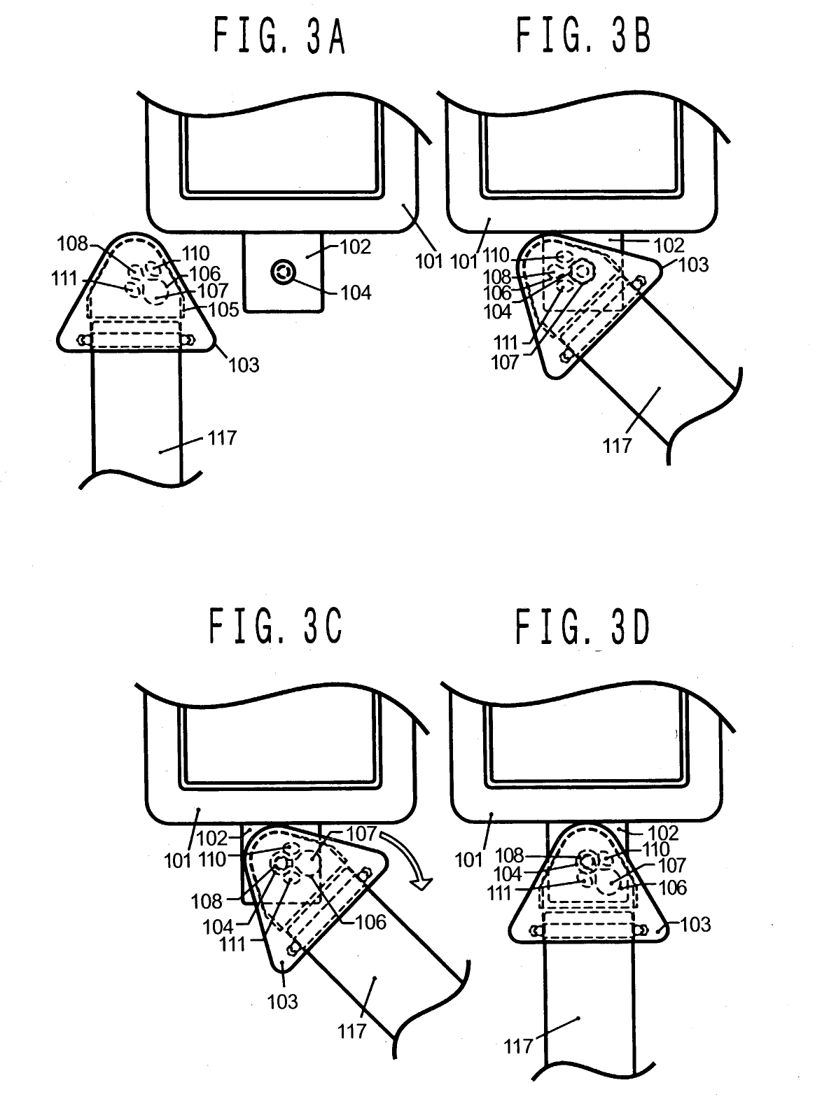

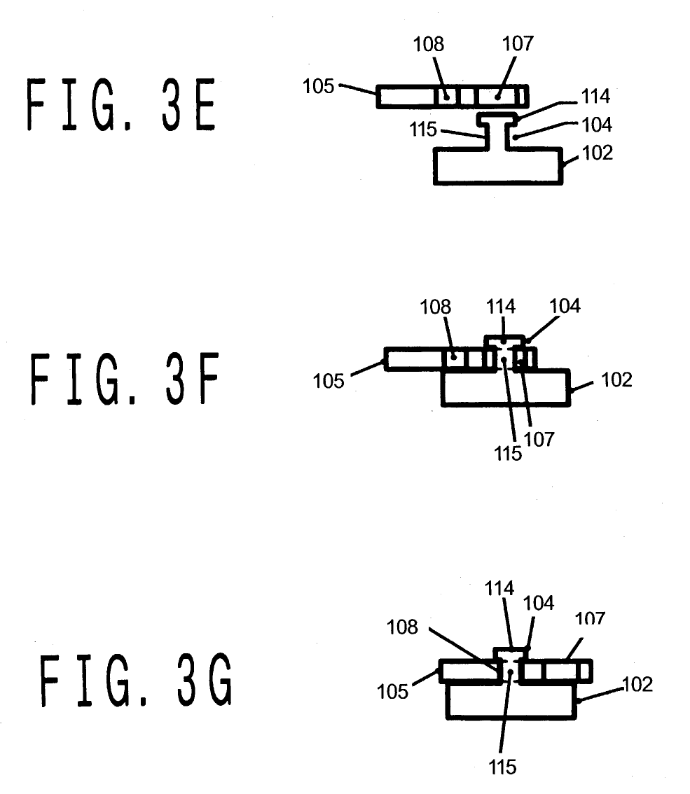

FIGS. 3 are explanatory drawings showing a process for fixing the strap connecting and disconnecting structure for portable timepieces according to a first mode of embodiment. Referring to FIGS. 3, FIGS. 3A to 3D are plan views showing a process for fixing the strap connecting and disconnecting structure to the case, and FIGS. 3E to 3G sectional views. In FIGS. 3, the parts identical with those shown in FIG. 1 and FIG. 2 are designated by the same reference numerals.

The operation of the strap connecting and disconnecting structure for portable timepieces according to the first mode of embodiment will now be described following FIG. 1 to FIGS. 3.

First, from the condition (FIGS. 3A and 3E) in which the strap 117 is separated from the case 101, the clasp 103 is inclined relatively to the case 101 so that the clasp 103 does not contact the case 101, and the pin 104 is inserted from the side thereof at which the larger-diameter portion 104 is exposed to the outside into the larger-diameter hole portion 107 (FIGS. 3B and 3F).

The clasp 103 and case 101 in this condition is moved relatively (FIGS. 3C and 3G) by an operating force of not lower than a predetermined level so that the smaller-diameter portion 115 engages the smaller-diameter hole portion 108 via the joint portion 109.

The joint hole portion 109 is formed to a width smaller than that of the smaller-diameter portion 115. However, when the smaller-diameter portion 115 is moved toward the smaller-diameter hole portion 108 by a force of not lower than a predetermined level, the smaller-diameter portion 115 passes through the joint hole portion 109. During this time, the springs 112, 113 are expanded by the smaller-diameter portion 115 to cause the joint hole portion 109 to be expanded, and the pin 104 passes through the joint hole portion 109 smoothly. Since the springs 112, 113 are restored to their original condition after the smaller-diameter portion 115 passes through the joint hole portion 109, the joint hole portion 109 is returned to its original smaller-width-carrying condition after the smaller-diameter portion 115 passes through the joint hole portion 109 to engage the smaller-diameter hole portion 108.

After the smaller-diameter portion 115 and smaller-diameter hole portion 108 are engaged with each other, the clasp 103 and case 101 are turned relatively to set the positional relation between the clasp 103 and case to the positional relation therebetween in a proper strap-fixed condition (in which an extension of the strap 117 is directed toward the case 101)(FIG. 3D). Thus, the connecting of one end portion of the strap 117 to the case 101 is completed.

The connecting of the other end portion of the strap 117 to the case is also done in the same manner. As a result, the connecting of the strap 117 to the case 101 is completed.

The structure is formed so that, in the condition in which the strap 117 is connected to the case 101, i.e., in the condition in which the smaller-diameter portion 115 and smaller-diameter hole portion 108 are engaged with each other, each of the distance L1 between the center of the larger-diameter hole portion 107 and the nearest end portion of the clasp 103, and that L2 between the center of the smaller-diameter hole portion 108 and the nearest end portion of the clasp 103 becomes shorter than the distance L3 between the center of the smaller-diameter hole portion 108 and the nearest end portion of the case 101. In this condition, the distance L between the center of the smaller-diameter hole portion 108 and the nearest end portion of the clasp 103 which is the closest to the case 101 is shorter than that L3 between the center of the smaller-diameter hole portion 108 and the nearest end portion of the case 101.

Therefore, in order to disconnect the fixing unit (clasp 103 and strap-connecting intermediate fastening plate 105) from the case 101 by disengaging the smaller-diameter portion 115 and smaller-diameter hole portion 108 from each other, it is necessary that the clasp 103 be turned to a position shown in FIG. 3C. In order to move the smaller-diameter portion 115 toward the larger-diameter hole portion 107, it is necessary that such a force of not lower than a predetermined level that allows the joint hole portion 109 to be expanded be applied. Therefore, in a normal condition of use of the timepiece, the occurrence of the inadvertent disengagement of the strap 117 from the case 101 can be prevented.

In order to remove the strap 117 from the case 101, the strap connecting operation described above may be carried out reversely by using an operating force of not lower than a predetermined level.

The strap connecting and disconnecting structure for portable timepieces in a second mode of embodiment of the present invention will now be described.

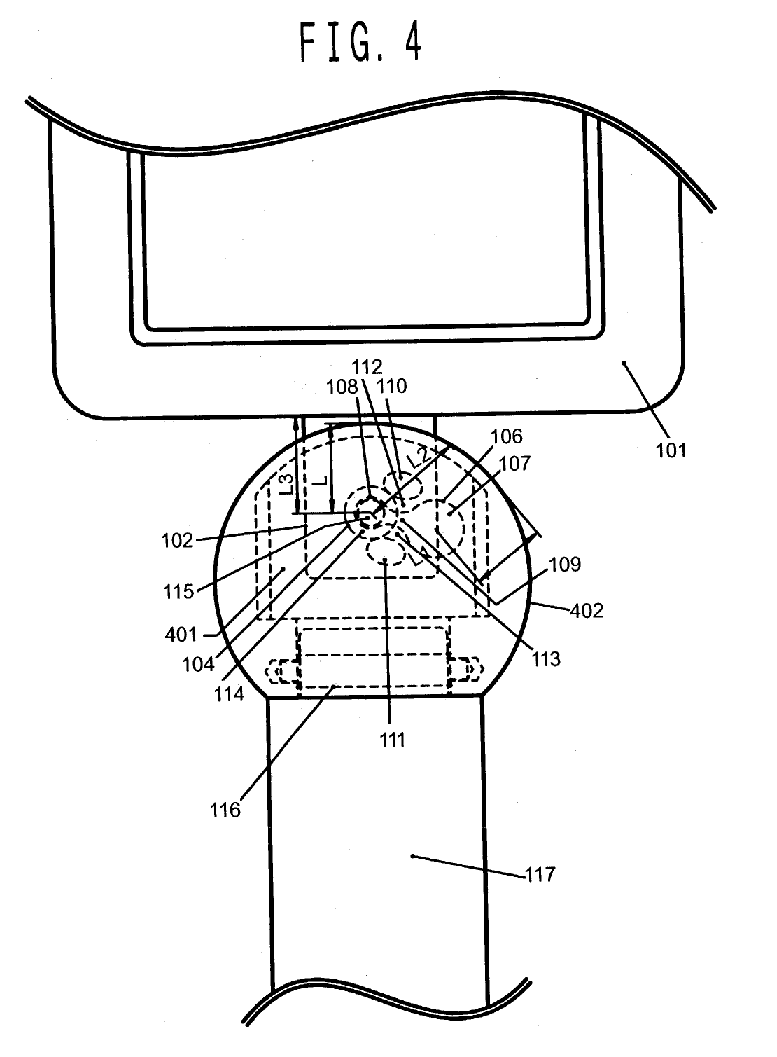

FIG. 4 is a plan view showing the strap connecting and disconnecting structure for portable timepieces in the second mode of embodiment of the present invention, in which the parts identical with those shown in FIG. 1 to FIGS. 3 are designated by the same reference numerals.

The points of difference between this second mode of embodiment and first mode of embodiment reside in an clasp 402 the shape of which is similar to that of a partly and linearly cut-off circular plate, and a strap-connecting intermediate fastening plate 401 which is provided so as to be integral with the clasp 402, and which is formed to a shape in conformity with that of the clasp 401.

The connecting and disconnecting of the strap 117 with respect to the case 101 are done in the same manner as in the first mode of embodiment. When the design of the clasp 402 and strap 117 is changed variously, it becomes possible to form a variety of portable timepieces.

As described above, the strap connecting and disconnecting structure for portable timepieces each of which has a timepiece body in which a movement is held in a case 101, a bow 102 provided on the case 101 so as to be integral therewith, and a strap 117, which is fastened to the bow 102, includes a fixing unit (an clasp 103 and a strap-connecting fastening plate 105) fastened to the strap 117, a locking pin 104 provided on either the fixing unit or bow 102, and a locking hole 106 engaged with the locking pin 104 and provided in the other thereof, the locking pin 104 having a larger-diameter portion 114 and a smaller-diameter portion 115, the locking hole 106 having a larger-diameter hole portion 107 larger than the larger-diameter portion 114, a smaller-diameter hole portion 108 smaller than the larger-diameter portion 114 and larger than the smaller-diameter portion 115, and a joint hole portion 109 having a width smaller than that of the smaller-diameter portion 115, and adapted to be expanded when the smaller-diameter portion 115 passes there through and connect the larger-diameter hole portion 107 and smaller-diameter hole portion 108 together.

Therefore, the user of the timepiece becomes able to connect and disconnect the strap to and from the timepiece body easily without using a special device.

It becomes possible that a bangle-like strap 117 having an appearance unitary with that of the timepiece body be used.

It also becomes possible that a combination of the timepiece body and strap 117 be changed variously.

The structure is formed so that, in the condition in which the fastening of the fixing unit to the bow 102 by engaging the locking pin 104 and the smaller-diameter hole portion 108 with each other is completed, each of the distance L1 between the center of the larger-diameter hole portion 107 and the nearest end portion of the fixing unit and that L2 between the center of the smaller-diameter hole portion 108 and the nearest end portion of the fixing unit is shorter than the distance L between the center of the smaller-diameter hole portion 108 and the end portion 101 of the fixing unit which is nearest to the case 101.

Therefore, it becomes possible to prevent an inadvertent fall of the strap 117.

Since a buckle is not used, it becomes possible to lessen the occurrence of damage to the strap 117.

It is preferable to provide bows (first and second bows) on both of the opposite sides of the case 101, and fixing units (first and second fixing units) on both end portions of the strap 117.

In each of the above-described modes of embodiment, the pin 104 is formed on the bow 102 so as to be integral therewith, and the locking hole 106 is made in the strap-connecting intermediate fastening plate 105. It is also allowable to form the pin 104 on the strap-connecting fastening plate 105 so as to be integral therewith, and a locking hole in the bow 102.

It is also allowable to form a pin on one bow so as to be integral therewith, and a locking hole in the other; and a locking hole in the strap-connecting intermediate fastening plate engaged with one bow, and a pin on the strap-connecting intermediate fastening plate engaged with the other.

According to the present invention, it becomes possible to connect and disconnect the strap easily to and from the timepiece body. It also becomes possible to prevent an inadvertent fall of the strap. It also becomes easy to form the strap and timepiece body so that these parts give an impression that a combination thereof has a unitary appearance. It further becomes possible to lessen the occurrence of damage to the strap.

What is claimed is:

1. A portable timepiece comprising:
a timepiece body in which a movement is held in a case;
a bow provided on the case so as to be integral therewith;
a strap, which is fastened to the bow;
a fixing unit fastened to the strap;
a locking pin provided on either the fixing unit or bow; and
a locking hole engaged with the locking pin and provided in the other thereof, wherein the locking pin have a larger-diameter portion and a smaller-diameter portion, the locking hole have a larger-diameter hole portion larger than the larger-diameter portion, a smaller-diameter hole portion smaller than the larger-diameter portion and larger than the smaller-diameter portion, and a joint hole portion having a width smaller than that of the smaller-diameter portion, and adapted to be expanded when the smaller-diameter portion passes therethrough, and connect the larger-diameter hole portion and smaller-diameter hole portion together.

2. A portable timepiece according to claim 1, wherein the portable timepieces are formed so that, in the condition in which the fastening of the fixing unit to the bow by engaging the locking pin and the smaller-diameter hole portion with each other is completed, a distance between the center of the larger-diameter hole portion and the nearest end portion of the fixing unit and that between the center of the smaller-diameter hole portion and the nearest end portion of the fixing unit are shorter than a distance between the center of the smaller-diameter hole portion and the end portion of the fixing unit which is closest to the case.

3. A portable timepiece according to claim 2, wherein spring-forming holes are provided in the vicinity of the joint hole portion, whereby springs are formed between the joint hole portion and spring-forming holes, the springs being expanded by the locking pin when the locking pin passes through the joint hole portion to cause the joint hole portion to be expanded.

4. A portable timepiece comprising:
a timepiece body in which a movement is held in a case;
a bow provided on the case so to be integral therewith;
a strap, which is fastened to the bow;
first and second bows provided on both of opposite sides of the case;
first and second fixing units provided on both end portions of the strap;
a first locking pin being provided on either the first fixing unit or first bow;
a first locking hole engaged with the first locking pin being provided in the other thereof;
a second locking pin being provided on either the second fixing unit or second bow; and
a second locking hole engaged with the second locking pin being provided in the other thereof, wherein the first and second locking pins have first and second larger-diameter portions and first and second smaller-diameter portions, the first and second locking holes have first and second larger-diameter hole portions larger than the first and second larger-diameter portions, first and second smaller-diameter hole portions smaller than the first and second larger-diameter portions and larger than the first and second smaller-diameter portions, and first and second joint hole portions having widths smaller than those of the first and second smaller-diameter portions, and adapted to be expanded when the first and second smaller-diameter portions pass therethrough and connect the first and second larger-diameter hole portions and first and second smaller-diameter hole portions together.

5. A portable timepiece according to claim 4, wherein the Portable timepieces are formed so that, in the condition in which the fixing of the fixing units to the bows by engaging the first and second locking pins and the first and second smaller-diameter hole portions with each other is completed, each of distances between the centers of the first and second larger-diameter hole portions and the nearest end portions of the first and second fixing units and each of those between the centers of the first and second smaller-diameter hole portions and the nearest end portions of the first and second fixing units are shorter than each of distances between the centers of the first and second smaller-diameter hole portions and the end portions of the fixing units which are closest to the case.

6. A portable timepiece according to claim 5, wherein first and second spring-forming holes are provided in the vicinity of the first and second joint hole portions, whereby first and second springs are formed between the first and second joint hole portions and first and second spring-forming holes, the first and second springs being expanded by the first and second locking pins when the first and second locking pins pass through the first and second joint hole portions, to cause the first and second joint hole portions to be expanded.
